(19) United States
(12) Patent Application Publication
(10) Pub. No.: US 2026/0024698 A1
(43) Pub. Date: Jan. 22, 2026

(54) MOUNTING STRUCTURE OF ELECTRONIC COMPONENT

(71) Applicant: Murata Manufacturing Co., Ltd., Kyoto-fu (JP)

(72) Inventor: Hideki SANADA, Nagaokakyo-shi (JP)

(73) Assignee: Murata Manufacturing Co., Ltd., Kyoto-fu (JP)

(21) Appl. No.: 19/261,520

(22) Filed: Jul. 7, 2025

(30) Foreign Application Priority Data
Jul. 16, 2024 (JP) 2024-113558

(51) Int. Cl. H01G 2/02; H01G 4/008; H01G 4/30

(52) U.S. Cl. CPC H01G 2/02; H01G 4/008; H01G 4/30

(57) ABSTRACT

The mounting structure of an electronic component is exposed to a high temperature, which may cause a decrease in bonding strength of the electronic component to the land of the substrate. A mounting structure of an electronic component includes a substrate having a land, a capacitor component having a first external electrode stacked on an outer surface of a base body, and a solder including Sn and Bi. The first external electrode is bonded to the land with the solder. One or more selected from the land and the first external electrode contain Ni. One or more selected from the land, the first external electrode, and the solder contain Au, and one or more selected from the land, the first external electrode, and the solder contain Cu. An alloy portion including Sn, Cu, Au, and Ni is further included in a region adjacent to the solder.

### CROSS-REFERENCE TO RELATED APPLICATION

This application claims benefit of priority to Japanese Patent Application No. 2024-113558, filed Jul. 16, 2024, the entire content of which is incorporated herein by reference.

### BACKGROUND

### Technical Field

The present disclosure relates to a mounting structure of an electronic component.

### Background Art

Japanese Patent Application Laid-Open No. 2022-111361 discloses a structure in which a multilayer ceramic capacitor is mounted on a land of a substrate by soldering. The multilayer ceramic capacitor of Japanese Patent Application Laid-Open No. 2022-111361 includes a dielectric layer, a plurality of internal electrode layers, and an external electrode. Each internal electrode extends inside the dielectric layer. In addition, the end portion of each internal electrode is exposed from the surface of the dielectric layer. The external electrode is stacked on the surface of the dielectric layer.

### SUMMARY

In the mounting structure of the electronic component as described in Japanese Patent Application Laid-Open No. 2022-111361, for example, the metal component included in the land of the board and the metal component included in the solder may be alloyed by exposure to high heat or elapse of time. This may cause a decrease in bonding strength of the electronic component to the terminal of the substrate, depending on the type of alloy generated in this way.

Accordingly, there is provided a mounting structure of an electronic component, including: a substrate having a land; an electronic component having a base body and an external electrode stacked on an outer surface of the base body; and solder containing Sn and Bi. The external electrode is joined to the land by the solder. Also, one or more selected from the land and the external electrode contain Ni, one or more selected from the land, the external electrode, and the solder contain Au, and one or more selected from the land, the external electrode, and the solder contain Cu, and the mounting structure further including an alloy portion containing Sn, Cu, Au, and Ni in a region adjacent to the solder.

The present disclosure can suppress a decrease in bonding strength of an electronic component to a land of a substrate.

### BRIEF DESCRIPTION OF THE DRAWINGS

FIG. 1 is a partial sectional perspective view of a capacitor component;

FIG. 2 is a partial sectional view of a mounting structure of a capacitor component;

FIG. 3 is a schematic view illustrating a substrate preparation step;

FIG. 4 is a schematic view illustrating a solder application step;

FIG. 5 is a schematic view illustrating an implementing step;

FIG. 6 is a schematic view illustrating a heating step; and

FIG. 7 is a graph showing a result of an impact resistance test of a capacitor component.

### DETAILED DESCRIPTION

Hereinafter, an embodiment of applying the present disclosure to a capacitor component 10 as an electronic component will be described with reference to the drawings. It is to be noted that components may be shown in an enlarged manner for easy understanding in the drawings. Dimensional ratios of the components may be different from actual ones or those in another drawing.

### <Capacitor Component>

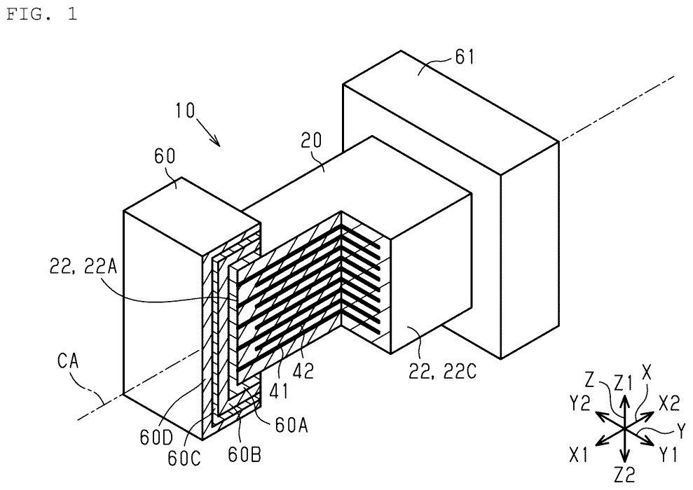

As illustrated in FIG. 1, the capacitor component 10 is a multilayer ceramic capacitor. The capacitor component 10 includes a base body 20. In FIG. 1, in order to illustrate the internal structure, a part of the capacitor component 10 is illustrated in a state of being virtually cut out. The base body 20 has a rectangular parallelepiped shape and has a central axis CA.

Hereinafter, an axis extending along the central axis CA is defined as a first axis X. In addition, one of axes that are orthogonal to the first axis X is defined as a second axis Y. Further, an axis that is orthogonal to the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Further, one of the directions along the third axis Z is defined as a third positive direction Z1, and a direction opposite to the third positive direction Z1 among the directions along the third axis Z is defined as a third negative direction Z2.

The outer surface of the base body 20 has six flat faces 22. It is to be noted that the term “surface” of the base body 20 as used herein refers to a part that can be observed as a surface when the whole base body 20 is observed. More specifically, for example, if there are such minute irregularities or steps that fail to be found unless a part of the base body 20 is enlarged and observed with a microscope or the like, the face is expressed as a flat face or a curved face.

The six flat faces 22 face in directions different from each other. The six flat faces 22 are roughly divided into a first end surface 22A facing the first positive direction X1, a second end surface facing the first negative direction X2, and four side surfaces 22C adjacent to the respective end surfaces. The four side surfaces 22C are a surface facing the third positive direction Z1, a surface facing the third negative direction Z2, a surface facing the second positive direction Y1, and a surface facing the second negative direction Y2, respectively.

As illustrated in FIG. 1, in the base body 20, the dimension in the direction along the first axis X is larger than the dimension in the direction along the second axis Y and the dimension in the direction along the third axis Z. The material of the base body 20 is a dielectric ceramic. Specifically, the material of the base body 20 contains BaTiO₃ as a main component. The “main component” means that the content ratio of the target substance exceeds 50%. For example, in the base body 20, the content ratio of BaTiO₃ exceeds 50 mol %. Alternatively, the material of the base body 20 may contain CaTIO₃, SrTiO₃, CaZrO₃, or the like as a main component. In addition, the material of the base body 20 may include a Mn compound, a Co compound, a Si compound, a compound containing a rare earth element, or the like as an accessory component.

As shown in FIG. 1, the capacitor component 10 includes five first internal electrodes 41 and four second internal electrodes 42. The first internal electrodes 41 and the second internal electrodes 42 are embedded in the base body 20. In FIG. 1, only a part of the first internal electrodes 41 of the first internal electrodes 41 are denoted by reference numerals. The same applies to the second internal electrodes 42.

The material of the first internal electrode 41 is a conductive material. Specifically, the material of the first internal electrodes 41 is Ni. The material of the second internal electrode 42 is the same as the material of the first internal electrode 41.

The first internal electrode 41 has a rectangular plate shape. The first internal electrode 41 has a main surface that is orthogonal to the third axis Z. The second internal electrode 42 has the same rectangular plate shape as the first internal electrode 41. The second internal electrode 42 has a main surface orthogonal to the third axis Z, as with the first internal electrode 41. The main surface herein refers to a flat face having the largest area among the outer surfaces of the plate-shaped object.

The dimension of the first internal electrode 41 in the direction along the first axis X is smaller than the dimension of the base body 20 in the direction along the first axis X. The dimension of the second internal electrode 42 in each of the directions is substantially the same as the dimension of the first internal electrode 41.

As shown in FIG. 1, the first internal electrode 41 and the second internal electrode 42 are located in a staggered manner in the direction along the third axis Z. That is, the first internal electrode 41, the second internal electrode 42, the first internal electrode 41, and the second internal electrode 42 are disposed in this order from the side surface 22C facing the third positive direction Z1 toward the third negative direction Z2. According to this embodiment, the distances between the respective internal electrodes in the direction along the third axis Z are equal to each other.

As shown in FIG. 1, the five first internal electrodes 41 and the four second internal electrodes 42 are both located at the center of the base body 20 in the direction along the second axis Y. On the other hand, as illustrated in FIG. 1, the first internal electrode 41 is close to the first positive direction X1. Although not illustrated, the second internal electrode 42 is closer to the first negative direction X2.

Specifically, as illustrated in FIG. 1, the end of the first internal electrode 41 on the first positive direction X1 side coincides with the end of the base body 20 on the first positive direction X1 side. Therefore, the end of the first internal electrode 41 on the first positive direction X1 side is exposed at the first end surface 22A. The end of the first internal electrode 41 on the first negative direction X2 side is located inside the base body 20, without reaching the end of the base body 20 on the first negative direction X2 side. On the other hand, although not illustrated, the end of the second internal electrode 42 on the first negative direction X2 side coincides with the end of the base body 20 on the first negative direction X2 side. Therefore, the end of the second internal electrode 42 on the first negative direction X2 side is exposed at the second end surface. The end of the second internal electrode 42 on the first positive direction X1 side is located inside the base body 20, without reaching the end of the base body 20 on the first positive direction X1 side.

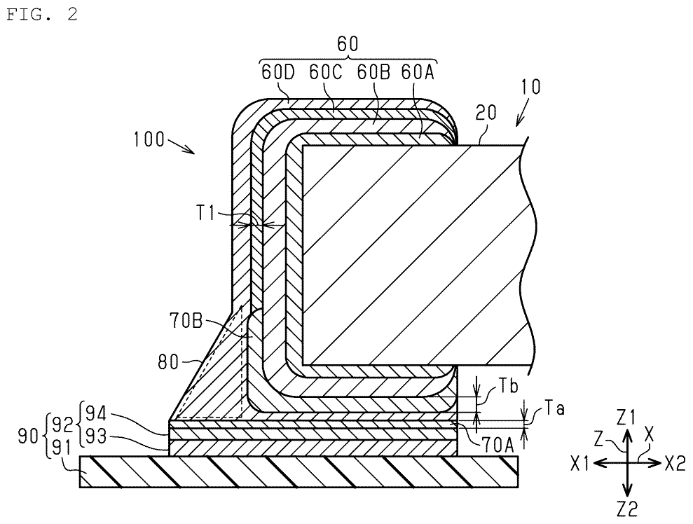

As shown in FIG. 1, the capacitor component 10 includes a first external electrode 60 and a second external electrode 61. The first external electrode 60 covers the first end surface 22A of the base body 20 and parts of the four side surfaces 22C thereof on the first positive direction X1 side. That is, the first external electrode 60 is a five-face electrode. As illustrated in FIG. 2, the first external electrode 60 includes a first base electrode layer 60A, a first Ni layer 60B, a first Cu layer 60C, and a first Sn layer 60D. The first base electrode layer 60A, the first Ni layer 60B, the first Cu layer 60C, and the first Sn layer 60D are stacked in this order from the outer surface side of the base body 20. In FIG. 2, illustration of each internal electrode inside the base body 20 is omitted.

The first base electrode layer 60A is stacked at a part of the outer surface of the base body 20, including the first end surface 22A. Specifically, the first base electrode layer 60A covers the first end surface 22A of the base body 20 and parts of the four side surfaces 22C thereof on the first positive direction X1 side. In the present embodiment, the material of the first base electrode layer 60A is Cu. The first base electrode layer 60A may contain a polymer compound including inorganic carbon and organic carbon.

The first Ni layer 60B is stacked on the first base electrode layer 60A. That is, the first Ni layer 60B covers the first base electrode layer 60A from the outside. The first Ni layer 60B contains Ni as a main component. The first Ni layer 60B is formed by, for example, Ni electroplating.

The first Cu layer 60C is stacked on the first Ni layer 60B. That is, the first Cu layer 60C covers the first Ni layer 60B from the outside. The first Cu layer 60 C covers 80% or more of the region of the outer surface of the first Ni layer 60B. In this embodiment, the first Cu layer 60C covers substantially the entire region of the first Ni layer 60B. The thickness of the first Cu layer 60C may be locally zero. However, the calculation of the above ratio does not include a portion in which the thickness of the first Cu layer 60C is zero and which cannot be observed without a microscope. That is, the above ratio is calculated by the overlapping region of the region surrounded by the outer edge of the first Cu layer 60C and the region surrounded by the outer edge of the first Ni layer 60B.

The first Cu layer 60C contains Cu as a main component. The first Cu layer 60C is formed by, for example, Cu electroplating. The average thickness T1 of the first Cu layer 60C is less than 6 μm. The average thickness T1 of the first Cu layer 60C in the first external electrode 60 is calculated as follows. First, a section including the inner surface on the base body 20 side and the outer surface on the opposite side in the first Cu layer 60C and orthogonal to the outer surface of the base body 20 is photographed with an electron microscope. Then, for the photographed image, a measurement range in a direction along the outer surface of the first Ni layer 60B is specified. The measurement range in this case is 10 μm or more. The measurement range may be continuously 10 μm or more, or the total of ranges at a plurality of different points may be 10 μm or more. The sectional area of the first Cu layer 60C in the measurement range is calculated by image processing. Then, a value obtained by dividing the calculated sectional area of the first Cu layer 60 C in the measurement range by the length of the measurement range is defined as the average thickness T1 of the first Cu layer 60C in the first external electrode 60.

The first Sn layer 60D is stacked on the first Cu layer 60C. That is, the first Sn layer 60D covers the first Cu layer 60C from the outside. The first Sn layer 60D contains Sn as a main component. The first Sn layer 60D is formed by, for example, electroplating of Sn.

The second external electrode 61 covers the second end surface of the base body 20 and a part of the four side surfaces 22C on the first negative direction X2 side. That is, the second external electrode 61 is a five-face electrode. The second external electrode 61 does not reach the first external electrode 60 on the side surface 22C, and is separated from the first external electrode 60 in the direction along the first axis X. On the side surface 22C of the base body 20, the first external electrode 60 and the second external electrode 61 are not stacked in a central portion in the direction along the first axis X.

Although not illustrated, the second external electrode 61 includes a second base electrode layer, a second Ni layer, a second Cu layer, and a second Sn layer. The configurations of the second base electrode layer, the second Ni layer, the second Cu layer, and the second Sn layer of the second external electrode 61 are the same as the configurations of the first base electrode layer 60A, the first Ni layer 60B, the first Cu layer 60C, and the first Sn layer 60D of the first external electrode 60. The average thickness of the second Cu layer is less than 6 μm, preferably 0.5 μm or more and 2 μm or less (i.e., from 0.5 μm to 2 μm).

### <Mounting Structure of Capacitor Component>

Then, a mounting structure 100 of a capacitor component 10 and a substrate 90 will be described. Hereinafter, the mounting structure of a first external electrode 60 and the substrate 90 of the capacitor component 10 will be described, but the same applies to a mounting structure of a second external electrode 61 and the substrate 90.

As illustrated in FIG. 2, the substrate 90 includes a substrate body 91 and a land 92. The substrate body 91 is made of an insulating material such as synthetic resin. The substrate body 91 has a plate shape. The land 92 is stacked on the main surface of the substrate body 91. The land 92 is a portion for mounting the capacitor component 10 described above. Although not illustrated, the land 92 is connected to wiring or the like extending on the substrate body 91.

The land 92 before mounting the capacitor component 10 includes a base layer 93, a first plating layer 94, and a second plating layer. The base layer 93, the first plating layer 94, and the second plating layer are stacked in this order from the substrate body 91 side. The main component of the base layer 93 is Cu. The main component of the first plating layer 94 is Ni. The main component of the second plating layer is Au. These layers may contain elements other than the element as the main component. In the process of solder bonding, most of Au in the second plating layer melts into a solder 80. Therefore, the clear second plating layer cannot be seen due to the bonding by the solder 80.

As shown in FIG. 2, the capacitor component 10 is bonded onto the land 92 of the substrate 90 with the solder 80 interposed therebetween. Specifically, in a state where the capacitor component 10 is mounted on the land 92 of the substrate 90, one surface of the first external electrode 60 of the capacitor component 10 faces the land 92. In the present embodiment, the surface of the first external electrode 60 facing the third negative direction Z2 faces the land 92. A part of the solder 80 is interposed between the land 92 and the first external electrode 60 facing the land 92.

The solder 80 is in contact with a surface of the first external electrode 60 facing the first positive direction X1. In addition, although not illustrated, the solder 80 is also in contact with the surface of the first external electrode 60 facing the second positive direction Y1 and the surface of the first external electrode 60 facing the second negative direction Y2. The solder 80 has a shape that spreads outward toward the substrate 90, that is, a fillet shape.

The solder 80 includes Sn and Bi. As described above, the first external electrode 60 has the first Sn layer 60D as the outermost layer. Therefore, the solder 80 is configured as an integral body without a clear boundary with respect to the first Sn layer 60D. In FIG. 2, a fillet shape portion indicated by a broken line is denoted by a reference sign as the solder 80 for convenience.

The mounting structure 100 includes a first alloy portion 70A and a second alloy portion 70B. The alloy herein is a concept including an intermetallic compound, a solid solution, and one in a cutectic state. Both the first alloy portion 70A and the second alloy portion 70B are in a region adjacent to the solder 80. The first alloy portion 70A is an alloy including Sn, Cu, Au, and Ni. In the present embodiment, each metal component is derived from a metal component contained in any of the first external electrode 60, the solder 80, and the land 92. The metal component constituting the second alloy portion 70B and the origin of the metal component are the same as those of the first alloy portion 70A.

The first alloy portion 70A is located in a region between the first plating layer 94 and the solder 80 of the land 92. The first alloy portion 70A is in a layer shape along the main surface of the land 92. The first alloy portion 70A extends over the entire main surface of the land 92. Such a shape is formed because the solder 80 wets and spreads over the entire main surface of the land 92 in a production process for producing the mounting structure 100.

The second alloy portion 70B is located in a region between the first external electrode 60 and the solder 80. In the present embodiment, not only the surface of the first external electrode 60 facing the third negative direction Z2 but also a part of the surface facing the first positive direction X1 is in contact with the solder 80. More specifically, a part of the surface facing the first positive direction X1 on the third negative direction Z2 side is in contact with the solder 80. In addition, although not illustrated, a part of the surface of the first external electrode 60 facing the second positive direction Y1 on the third negative direction Z2 side and a part of the surface facing the second negative direction Y2 on the third negative direction Z2 side are in contact with the solder 80. Reflecting such a positional relationship between the first external electrode 60 and the solder 80, the second alloy portion 70B exists on the entire surface of the first external electrode 60 being in contact with the solder 80.

The average thickness Tb of the second alloy portion 70B is larger than the average thickness Ta of the first alloy portion 70A. Specifically, the average thickness Tb of the second alloy portion 70B is 1.5 times or more and 6 times or less (i.e., from 1.5 times to 6 times) the average thickness Ta of the first alloy portion 70A. The average thickness of each alloy portion can be calculated in the same manner as the average thickness T1 of the first Cu layer 60C in the first external electrode 60.

### <Method for Producing Mounting Structure>

The method for producing the mounting structure 100 includes a substrate preparation step, a solder application step, an implementing step, and a heating step.

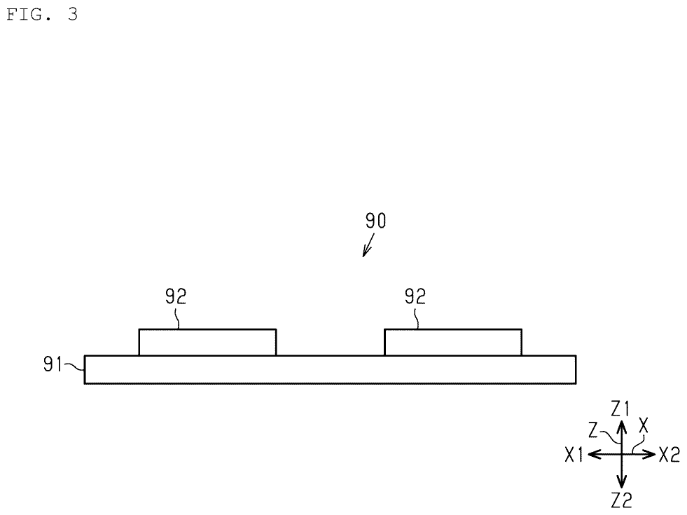

First, as illustrated in FIG. 3, a substrate preparation step is performed. In the substrate preparation step, the substrate 90 is placed at a predetermined position. The substrate 90 has a pair of lands 92 for one capacitor component 10 to be mounted. The pair of lands 92 are disposed at intervals in a direction parallel to the main surface of the substrate body 91. The interval between the pair of lands 92 is shorter than the distance from the first end surface 22A to the second end surface of the capacitor component 10 in the direction along the first axis X. In addition, the area of the main surface of each land 92 is larger than the area of the surface of the capacitor component 10 facing the third negative direction Z2 side of the first external electrode 60.

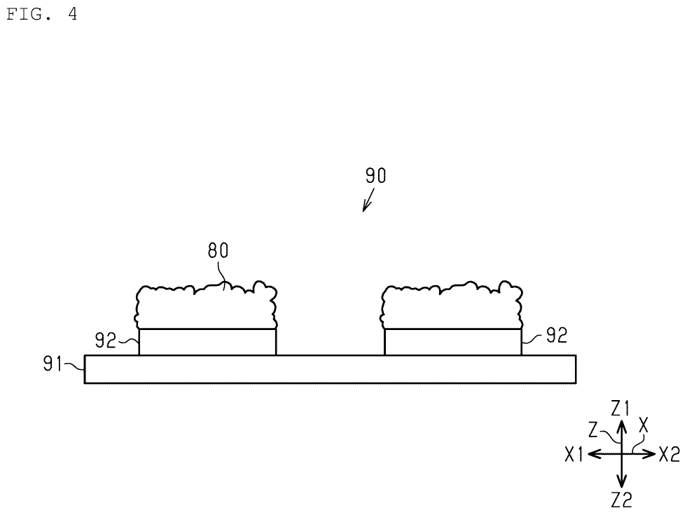

Then, as illustrated in FIG. 4, a solder application step is performed. In the solder application step, a solder paste including a solder 80 is applied onto each land 92 on the substrate 90. In this embodiment, a solder paste including the solder 80 is applied to the entire main surface of each land 92. The solder paste is prepared by mixing and stirring solder particles including Sn-58Bi, which is a base of the solder 80, a flux, a thixotropic agent, and the like. The solder particle size is 3 μm or more and 60 μm or less (i.e., from 3 μm to 60 μm) in terms of a median size. The content of the flux is 5% by weight or more and 20% by weight or less (i.e., from 5% by weight to 20% by weight) with respect to the total weight.

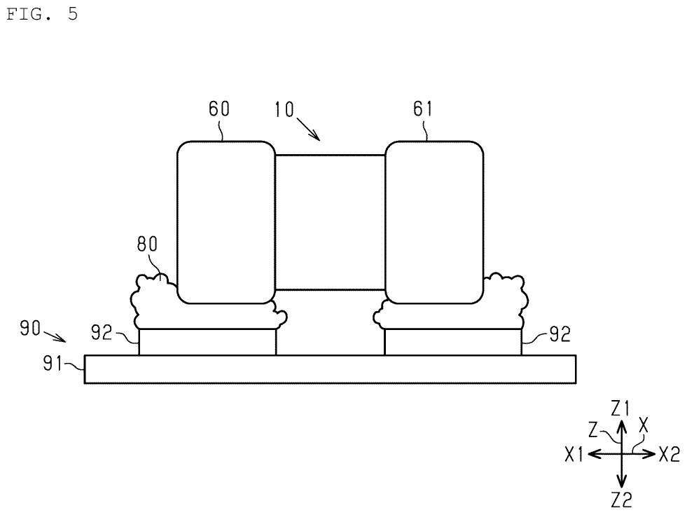

Then, as illustrated in FIG. 5, the implementing step is performed. In the implementing step, the capacitor component 10 is placed on the pair of lands 92. Specifically, the first external electrode 60 is placed on the main surface of one land 92, and the second external electrode 61 is placed on the main surface of the other land 92. As described above, the solder paste including the solder 80 is already applied onto each land 92, and thus the solder 80 is interposed between each land 92 and the capacitor component 10 in a state where the capacitor component 10 is placed in the implementing step.

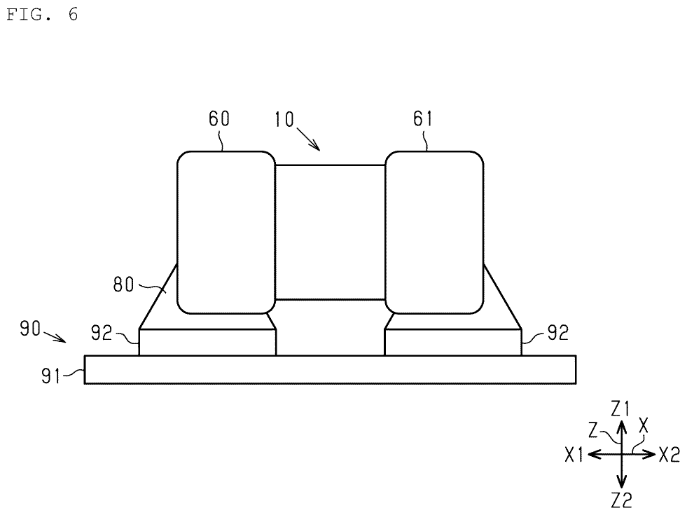

Then, as illustrated in FIG. 6, the heating step is performed. In the heating step, the solder 80 is heated to be melted. Specifically, the entire substrate 90 and capacitor component 10 are heated in a heating furnace. The heating temperature in this case is a temperature at which the solder 80 is melted and the substrate 90 and the capacitor component 10 are not thermally damaged. When the solder 80 is melted, the solder wets and spreads on the surface of the first external electrode 60 facing the first positive direction X1, the surface thereof facing the second positive direction Y1, and the surface thereof facing the second negative direction Y2. As a result, the solder 80 has a fillet shape. The same applies to the second external electrode 61.

### <Comparative Test>

The results of testing the impact resistance of the capacitor component will be described. Samples A, B, C, D, and E of the mounting structure described below were subjected to the test. The structure and material of these samples conform to the structure and material of the mounting structure 100 of the above embodiment unless otherwise specified. In addition, sample A is a sample prepared for comparison.

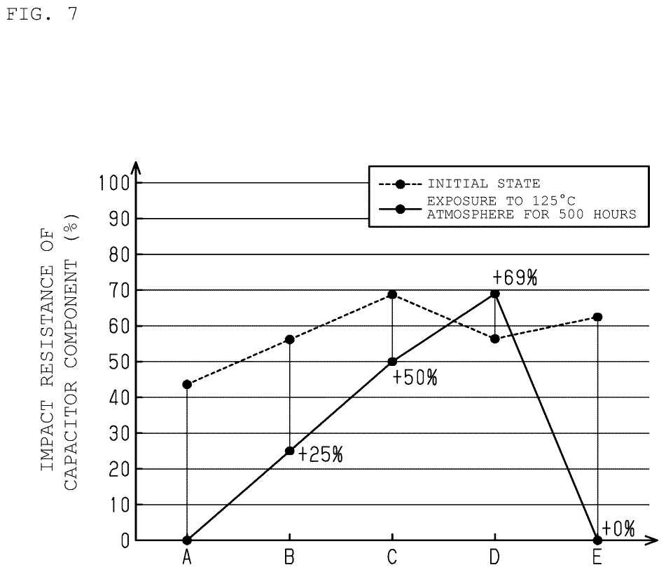

As illustrated in FIG. 7, for samples A, B, C, D, and E, the material of the solder is Sn-58Bi. Among samples A, B, C, D, and E, for samples B, C, D, and E, each external electrode of the capacitor component has a Cu layer. In other words, for sample A, each external electrode of the capacitor component does not have a Cu layer. For sample B, an average thickness of the Cu layer of each external electrode is 0.5 μm. For sample C, an average thickness of the Cu layer of each external electrode is 1 μm. For sample D, an average thickness of the Cu layer of each external electrode is 2 μm. For sample E, an average thickness of the Cu layer of each external electrode is 6 μm.

In this comparative test, samples A, B, C, D, and E were exposed to an atmosphere of 125° C. for 500 hours. Thereafter, the impact resistance of the capacitor component to the substrate was examined for samples A, B, C, D, and E. Similarly, the impact resistance of the capacitor component to the substrate for samples A, B, C, D, and E in the initial state was examined. Herein, the “initial state” refers to a state before each mounting structure is exposed to an atmosphere of 125° C. The number of specimens of each sample is 16.

A method for evaluating impact resistance in this comparative test will be described. The impact resistance in this comparative test was evaluated by a so-called pendulum impact test. Specifically, the substrate on which the capacitor component had been mounted was attached to the pendulum impact test so as to swing down the substrate from the third negative direction Z2 of the first external electrode 60 in FIG. 2 to the third positive direction Z1. The impact generated by moving and suddenly stopping the pendulum attached in this manner was applied 1000 times to each of 16 samples of the same type. Then, the ratio of the capacitor component remaining without dropping among these 16 samples was used as an index indicating impact resistance.

When the capacitor component dropped before the number of drop impacts reached 1000 times for a specific sample, the test was terminated at that stage for the sample. Then, when the capacitor component dropped before the number of drop impacts reached 1000 times for all 16 samples of the same type, the number of times when the capacitor component dropped for the last one sample was used as an index of impact resistance.

According to this comparative test, the impact resistance of samples A, B, C, D, and E in the initial state is as indicated by broken lines in FIG. 7. That is, the impact resistance of sample A was 44%. The impact resistance of sample B was 56%. The impact resistance of sample C was 69%. The impact resistance of sample D was 56%. The impact resistance of sample E was 63%. As described above, when the external electrode of the capacitor component had the Cu layer, the impact resistance was significantly improved as compared with the case where the external electrode did not have the Cu layer.

In contrast, the impact resistance of samples A, B, C, D, and E exposed to an atmosphere at 125° C. for 500 hours is as indicated by solid lines in FIG. 7. That is, for sample A, all the 16 capacitor components dropped with 200 times of drop impacts. The impact resistance of sample B was 25%. The impact resistance of sample C was 50%. The impact resistance of sample D was 69%. That is, for sample E, all the 16 capacitor components dropped with 400 times of drop impacts. As described above, when the external electrode of the capacitor component had the Cu layer, a decrease in impact resistance due to high heat could be suppressed as compared with the case where the external electrode did not have the Cu layer. Further, some of samples B to D withstood the above pendulum impact test after exposure to high temperatures. Therefore, it has been found that the average thickness of the Cu layer is particularly preferably 0.5 μm or more and 2 μm or less (i.e., from 0.5 μm to 2 μm).

Further, when the external electrode did not have the Cu layer and the capacitor component drops, the side closer to the substrate in the bonding portion between the capacitor component and the land was broken. In contrast, when the external electrode had the Cu layer and the capacitor component drops, the second alloy portion or the vicinity thereof was broken.

### Effects of Embodiment

The advantageous effects of the present embodiment will be described.
(1) In the above embodiment, the Ni component is included in each external electrode of the capacitor component 10 and the land 92 of the substrate 90. Further, the land 92 includes an Au component. Therefore, when the substrate 90 and the capacitor component 10 are exposed to a high temperature or a temperature change, an alloy of the above components and Sn included in the solder 80 is generated. Specifically, an alloy of the Ni component and Sn included in the solder 80 and an alloy of the Ni, the Sn, and the Au are generated. The alloy of Ni—Sn and the alloy of Ni—Sn—Au are brittle compared to the solder 80, and thus formation of a layer of the alloy as described above causes a decrease in the bonding strength of the capacitor component 10 to the substrate 90.

In this respect, when each external electrode has a Cu layer, an alloy of Ni—Sn—Au—Cu is generated. The Ni—Sn—Au—Cu alloy has higher strength than the Ni—Sn alloy and the Ni—Sn—Au alloy. In contrast, each of the external electrodes and the land 92 has Cu, thereby suppressing the formation of an alloy of Ni—Sn and an alloy of Ni—Sn—Au. Therefore, the above embodiment suppresses a decrease in the bonding strength between the land 92 and the capacitor component 10.
(2) In the above embodiment, an alloy of Ni—Sn—Au—Cu exists in a region between the land 92 and the solder 80 and in a region between the solder 80 and each external electrode. Each of these regions is a boundary portion between the solder and another object, and thus is a portion where peeling of the solder is likely to occur. Further, this is a portion where components such as Ni and Au are likely to migrate from the land 92 and each external electrode. In other words, these regions are portions where the bonding strength is weak and portions where an alloy that causes a decrease in the bonding strength, such as an alloy of Ni—Sn and an alloy of Ni—Sn—Au, is likely to occur. The presence of an alloy of Ni—Sn—Au—Cu at such a position is particularly suitable for suppressing a decrease in bonding strength between the capacitor component 10 and the land 92.
(3) In the above embodiment, the average thickness Tb of the second alloy portion 70B is larger than the average thickness Ta of the first alloy portion 70A. This can prevent the substrate 90 from being broken. In the rare case that the capacitor component 10 drops, the drop is probably caused by the breakage of the second alloy portion 70B not the substrate 90. Thus intentionally making the substrate 90 likely to be broken on the side far from the land 92 allows the influence of the breakage to be prevented from being exerted on the substrate 90 side in the rare case that breakage occurs between the capacitor component 10 and the substrate 90.
(4) As in the above embodiment, each external electrode contains Cu, causing the average thickness Tb of the second alloy portion 70B to tend to be larger than the average thickness Ta of the first alloy portion 70A when the mounting structure 100 is produced. Therefore, the relationship between the average thicknesses of the alloy portions can be achieved without adopting a special production process for increasing the average thickness Tb of the second alloy portion 70B.
(5) According to the present comparative test, when the first Cu layer 60C of the external electrode is 6 μm thick, the bonding strength of the capacitor component 10 to the substrate 90 is lower than that when the first Cu layer 60C is 2 μm thick. That is, when the average thickness T1 of the first Cu layer 60C is 6 μm or more, the effect of suppressing a decrease in bonding strength decreases. In addition, as the average thickness T1 of the first Cu layer 60C is thicker, the overall thickness of each external electrode is larger, and thus the size of the capacitor component 10 is also larger. Therefore, from the viewpoint of preventing the size of the capacitor component 10 from increasing while obtaining the effect of the first Cu layer 60C, the first Cu layer 60C is preferably less than 6 μm thick.

### Modification Examples

The present embodiment can be modified and implemented as follows. The present embodiment and the following modification examples can be carried out in combination with each other within a range not technically contradictory.

The shape of the base body 20 is not limited to a rectangular parallelepiped.

The first external electrode 60 is not limited to the five-face electrode as shown in the example of the above embodiment. For example, there may be a side surface 22C on which the first external electrode 60 is not disposed. For example, the first external electrode 60 may not be disposed on the first end surface 22A. Regardless of the shape of the first external electrode 60, the electrical connection between the land 92 and the capacitor component 10 may be secured. In this respect, the same applies to the second external electrode 61.

In the above embodiment, the example in which the capacitor component 10 is adopted as the electronic component has been described, but the type of the electronic component is not limited to the multilayer ceramic capacitor. Any electronic component having the base body 20 and the external electrode can be applied. Examples of this type of the electronic component include a piezoelectric component, a thermistor, and an inductor. In addition, the base body 20 of the electronic component is not limited to one including a dielectric, and may include, for example, a magnetic body, a piezoelectric body, or a metal magnetic body.

The numbers of the first internal electrodes 41 and the second internal electrodes 42 are not limited to the example of the embodiment mentioned above. The number of the first internal electrodes 41 may be less than or more than five. In this respect, the same applies to the second internal electrodes 42.

The material of the solder 80 is not limited to Sn-58Bi as long as it includes Sn and Bi. For example, the solder 80 may include one or more selected from Pb, Ag, and Cu in addition to Sn and Bi.

Main components of the first plating layer 94 and the second plating layer of the land 92 are not limited to the example of the present embodiment. The main component of the first plating layer 94 may not be Ni. In addition, the main component of the second plating layer may not be Au. The electrical connection between the land 92 and the electronic component may be secured. When any of the land 92, the solder 80, and the first external electrode 60 includes Ni and Au, an alloy of Sn, Ni, and Au is generated, which may cause a problem of reducing the bonding strength.

The main component of the base layer 93 of the land 92 is not limited to the example of the present embodiment.

The material of the first external electrode 60 is not limited. In addition, the first external electrode 60 may have a single-layer structure and a double-layer structure, or may have a multilayer structure of five or more layers. In this respect, the same applies to the second external electrode 61.

In the above embodiment, an example in which each external electrode contains Cu has been described, but the solder 80 or the land 92 may contain Cu instead of each external electrode. In addition, although the example in which the main component of the second plating layer of the land 92 is Au is shown, the solder 80 or each external electrode may contain Au instead of the land 92. That is, when any of each external electrode, the land 92, and the solder 80 includes Cu and Au, an alloy portion including Sn, Cu, Au, and Ni may be generated.

The average thickness T1 of the first Cu layer 60C of the first external electrode 60 may be 6 μm or more. In this respect, the same applies to the second external electrode 61.

The average thickness Tb of the second alloy portion 70B may be smaller than the average thickness Ta of the first alloy portion 70A.

The solder 80 may not spread over the entire main surface of the land 92. The electrical connection between the land 92 and the capacitor component 10 may be secured. In this respect, the same applies to the second external electrode 61.

There may be no fillet shape. For example, the solder 80 may not have a clear fillet shape. In addition, the area of the main surface of the land 92 may be smaller than the area of the surface of the first external electrode 60 facing the main surface of the land 92.

Each alloy portion is not necessarily layered. In addition, the alloy portion may be buried in the solder 80 or may be exposed to the outside of the solder 80. When the alloy portion is present in the region adjacent to the solder 80 as described above, the formation of the brittle alloy exemplified in the above embodiment can be suppressed regardless of the shape of the alloy portion.

### <Supplementary Note>

A technical idea that can be grasped from the above embodiment and modifications will be described.
[1] There is provided a mounting structure of an electronic component, including: a substrate having a land; an electronic component having a base body and an external electrode stacked on an outer surface of the base body; and solder containing Sn and Bi, in which the external electrode is joined to the land by the solder. One or more selected from the land and the external electrode contain Ni, one or more selected from the land, the external electrode, and the solder contain Au, and one or more selected from the land, the external electrode, and the solder contain Cu, and the mounting structure further including an alloy portion containing Sn, Cu, Au, and Ni in a region adjacent to the solder.
[2] The mounting structure of an electronic component according to [1], in which the alloy portion is located in one or more regions selected from a region between the land and the solder and a region between the external electrode and the solder.
[3] The mounting structure of an electronic component according to [1] or [2], including, as the alloy portion, a first alloy portion located in a region between the land and the solder, and a second alloy portion located in a region between the solder and the external electrode.
[4] The mounting structure of an electronic component according to any one of [1] to [3], in which an average thickness of the second alloy portion is larger than an average thickness of the first alloy portion.
[5] The mounting structure of an electronic component according to any one of [1] to [4], in which the external electrode contains Cu.
[6] The mounting structure of an electronic component according to any one of [1] to [5], in which the base body has a rectangular parallelepiped shape, and the external electrode is disposed on one or more flat faces selected from one end surface and four side surfaces adjacent to the end surface among six flat faces constituting an outer surface of the base body.
[7] The mounting structure of an electronic component according to any one of [1] to [6], in which the external electrode includes a base electrode layer stacked on an outer surface of the base body, and a Cu layer located on a side opposite to the base body with respect to the base electrode layer and containing Cu as a main component, and an average thickness of the Cu layer is 0.5 μm or more and less than 6 μm (i.e., from 0.5 μm to less than 6 μm).

What is claimed is:

1. A mounting structure of an electronic component, comprising:
a substrate having a land;
an electronic component having a base body and an external electrode stacked on an outer surface of the base body; and
solder including Sn and Bi,
wherein
the external electrode is joined to the land by the solder,
one or more selected from the land and the external electrode include Ni,
one or more selected from the land, the external electrode, and the solder include Au, and
one or more selected from the land, the external electrode, and the solder include Cu,
the mounting structure further comprising an alloy portion including Sn, Cu, Au, and Ni in a region adjacent to the solder.

2. The mounting structure of an electronic component according to claim 1, wherein
the alloy portion is in one or more regions selected from a region between the land and the solder and a region between the external electrode and the solder.

3. The mounting structure of an electronic component according to claim 1, comprising, as the alloy portion,
a first alloy portion in a region between the land and the solder, and
a second alloy portion in a region between the solder and the external electrode.

4. The mounting structure of an electronic component according to claim 3, wherein
an average thickness of the second alloy portion is larger than an average thickness of the first alloy portion.

5. The mounting structure of an electronic component according to claim 3, wherein
the external electrode includes Cu.

6. The mounting structure of an electronic component according to claim 1, wherein
the base body has a rectangular parallelepiped shape, and
the external electrode is on one or more flat faces selected from one end surface and four side surfaces adjacent to the end surface among six flat faces configuring an outer surface of the base body.

7. The mounting structure of an electronic component according to claim 1, wherein
the external electrode includes a base electrode layer stacked on an outer surface of the base body, and a Cu layer on a side opposite to the base body with respect to the base electrode layer and including Cu as a main component, and
an average thickness of the Cu layer is from 0.5 μm to less than 6 μm.
